(19) United States
(12) Patent Application Publication
(10) Pub. No.: US 2007/0135309 A1
(43) Pub. Date: Jun. 14, 2007

(54) Feeder cart used to integrate feeder mechanisms and surface mount machines of varying types

(76) Inventor: Michael Swab, Acworth, GA (US)

Correspondence Address: FOLEY AND LARDNER LLP;SUITE 500, 3000 K STREET NW, WASHINGTON, DC, 20007, US

(21) Appl. No.: 10/537,990

(22) PCT Filed: Dec. 8, 2003
(86) PCT No.: PCT/IB03/05802

§ 371 Date: Jun. 16, 2006

Related U.S. Application Data
(60) Provisional application No. 60/432,299, filed on Dec. 10, 2002.

(30) Foreign Application Priority Data
Mar. 25, 2003 (DE) 103-13-389.5

(51) Int. Cl. H01F 7/02

(52) U.S. Cl. 505/212

(57) ABSTRACT

An interfacing device that integrates feeder mechanisms and surface mount machines of differing manufactures seamlessly. This device includes a carriage to which a feeder plate mechanism is mounted. The carriage couples external feeder connectors from a surface mount machine to the feeder plate mechanism. A number of feeder mechanisms received by the feeder plate mechanism interface with internal feeder connectors to the feeder plate mechanism. Thus, the feeder plate mechanism adapts external feeder connectors to internal feeder connectors, thereby allowing feeder mechanisms of varying manufacture to be used with differing surface mount machines.

The present invention relates generally to feeder mechanisms and surface mount machines, and more particularly, to a system and method for seamlessly integrating feeder mechanisms with surface mount assembly machines, wherein the feeder mechanisms were not specifically designed to integrate with the individual surface mount assembly machines.

Fully automated surface mount assembly machines populate printed circuit boards (PCB) with various components. These tools dramatically raise the productivity in component assembly and lower the cost of production. Each tool is typically designed to work with specific conventional feeders (feeder mechanisms). These feeder types may include bulk, tape, tube, and other like configurations. Tape mechanisms allow surface mount assembly machines to sequentially index carrier tape that contains surface mount electronic components within uniformly spaced cavities. Furthermore, these feeder mechanisms present the components consistently and repeatedly at a proscribed “dead spot” (a/k/a pick point) for pickup by a pickup head and subsequent assembly placement by the surface mount machine.

Currently, carrier tape packaging with small surface mount components therein feeds through the tape feeder designed for that surface mount machine to the surface mount machine that picks up the component at the designated pick point and places the surface mount component on the printed circuit board (PCB). A principal disadvantage associated with conventional tape feeders, is that these feeder mechanisms are machine specific and thus not interchangeable for use with other types of surface mount assembly machines. In other words, virtually every type and style of conventional tape feeder is manufactured for a particular make and model of a surface mount assembly machine and cannot be used with other types of surface mount assembly machines. This creates a proliferation of conventional tape feeders needed in a modern factory where surface mount assembly machines are utilized. Typically, the capital investment and floor space requirements for backup tape feeders exceeds the corresponding investment and space requirements for the assembly machine themselves.

Another disadvantage of conventional tape feeders is that the feeder mechanisms are dedicated to one specific type of carrier tape and different feeders must be used for each carrier tape used.

One prior art solution to this problem has been provided in U.S. Pat. No. 5,941,674 issued to Briehl, entitled “Interchangeable Electronic Carrier Tape Feeder Adaptable to Various Surface Mount Assembly Machines”. This solution provides an apparatus for feeding a carrier tape with successive sprocket holes and indexed pockets for carrying small components, and used in conjunction with various pick and place assembly machines for surface-mounting of the small components onto a printed circuit board or other assembly substrate. Briehl teaches an interchangeable electronic feeder adaptable to various surface mount assembly machines with a set of height support adapters. However, Briehl fails to address the existing plethora of existing feeder mechanisms in inventory by providing yet another feeder mechanism, which further complicates the issue as opposed to utilizing existing feeders.

It is therefore highly desirable to have a very efficient and very effective design and construction of an interchangeable feeder apparatus adaptable to various surface mount assembly machines, thereby eliminating the need to match a particular feeder to a particular surface mount assembly machine.

The present invention provides a system and method of seamlessly integrating feeder mechanisms to surface mount assembly tools that differ in manufacturer and that substantially eliminates or reduces disadvantages and problems associated with previously-developed solutions.

More specifically, the present invention provides an interfacing device that integrates feeders mechanisms and surface mount machines of differing manufacture. This interfacing device includes a carriage to which a feeder plate mechanism is mounted. The carriage provides external feeder connectors from the surface mount machine to the feeder plate mechanism. Feeder mechanisms, received by the feeder plate mechanism, have internal feeder connectors, which connect from the feeder plate mechanism to the feeder mechanisms themselves. Thus, the feeder plate mechanism can adapt the external feeder connectors on a particular surface mount machine of one manufacturer to the internal feeder connectors of the feeder mechanisms of another manufacturer.

These external feeder connectors and internal feeder connectors include pneumatic, mechanical, and electrical connections. A switch (mechanical, electrical, or software controlled) within the surface mount machines allows operators to select the type of feeder mechanism loaded within the interface device. Alternatively, the selector may be located within the interfacing device. Positioning pins within the interfacing device align components coupled by the internal feeder connectors and external feeder connectors. These components primarily consist of the feeder mechanism and the feeder plate mechanisms. Typically, the feeder plate has a top plate assembly that may be exchanged and thus allows the feeder plate mechanism to adapt mechanically to differing surface mount machines.

The carriage further may include a tape dump operable to catch spent feeder tape expended by feeder mechanism. This eliminates the danger and need for cutters often associated with spent tape. Additionally, the carriage may be mounted on casters that allow operators to easily reposition the interfacing device to and from surface mount machines. The frame of the carriage may also be adjustable in height in order to facilitate coupling the interfacing to surface mount tools or the use of the interfacing device with tools of device differing heights. These height differences typically arise from variations in how individual tools are facilitated.The embodiments primarily discussed utilize tape feeder mechanisms. However, the present invention may be applied equally to tape, bulk, tube or other such feeder mechanisms as are known to those skilled in the art.

Another embodiment provides a method of interfacing and integrating feeders mechanisms to surface mount machines of differing manufacture. This method includes first mounting a feeder plate mechanism to a carriage, wherein the carriage provides a platform for external feeder connectors from the surface mount machine to the feeder plate mechanism. A number of feeder mechanisms are then coupled to the feeder plate mechanism via internal feeder connectors. The feeder plate mechanism acts to adapt the external feeder connectors from the surface mount machine to the internal feeder connectors. When the carriage is coupled to the surface mount machine, a selection via a switch designates the type of feeder mechanisms contained within the feeder plate mechanism.

As previously stated, the external feeder connectors and internal feeder connectors may include both pneumatic and electrical connections. Furthermore, positioning pins within the interfacing device align the surface mount machine to the carriage, external connectors to the surface mount machine and feeder plate mechanism, and internal connectors to the feeder plate mechanism and feeder mechanisms themselves. An optional tape dump may catch spent feeder tape. This may eliminate the need for dangerous cutters that removed previously spent tape.

Operators may easily reposition the carriage with casters or wheels to and from the surface mount machine in a horizontal plane. An adjustable height mechanism within the frame of the carriage allows the operator to easily reposition a carriage to and from the surface mount machine in a vertical plane.

Yet another embodiment of the present invention incorporates many of these features. Such an interfacing device includes a carriage to which a feeder plate mechanism is mounted, wherein the carriage provides external feeder connectors from the surface mount machine to the feeder plate mechanism, wherein these external feeder connectors include both pneumatic and electrical connections. A number of feeder mechanisms received by the feeder plate mechanism wherein internal feeder connectors couple the feeder plate mechanism and feeder mechanisms pneumatically and electrically. Thus, the feeder plate mechanism serves to adapt the external feeder connectors from the surface mount machine to internal feeder connectors of a different type. Mechanical stops and positioning pins secure the feeder mechanisms and feeder plate mechanism to the surface mount machine/carriage assembly. A means for selecting a type of feeder mechanism is located within the interface device or the surface mount machine.

The carriage may further include both a tape dump operable to catch spent feeder tape expended by feeder mechanism, casters that allow an operator to easily reposition the interfacing device to and from the surface mount machine, and a means for adjusting a height of the carriage.

The present invention provides an advantage by offering the ability to interchangeably use feeder mechanisms with various surface mount assembly machines.

The repositionable carriage of the present invention provides a set of height support adapters so that the feeder plate mechanism can be adjusted to the pick height requirement for each surface mount assembly machine. These height differences typically arise from variations in how individual tools are facilitated.

The present invention also may incorporate both flip-chip and non-flip-chip capabilities, and the ability to accommodate different carrier tape widths. Additionally, the present invention may incorporate bare die abilities as well.

The present invention provides a significant advantage by allowing feeders to be among various surface mount machines with the selection of an appropriately configured interfacing device, thus allowing manufacturers to use their existing inventory of feeder mechanisms with a diverse set of surface mount machines.

In the one embodiment of the present invention, the interchangeable electronic feeder incorporates both flip-chip and non-flip-chip capabilities. Yet, in another alternative embodiment of the present invention, the interchangeable feeder mechanism comprises only a non-flip-chip capability, wherein it may be used for a wide range of surface mount components, including but not limited to singular bare die.

Further novel features and other objects of the present invention will become apparent from the following detailed description, discussion and the appended claims, taken in conjunction with the drawings.

For a more complete understanding of the present invention and the advantages thereof, reference is now made to the following description taken in conjunction with the accompanying drawings in which like reference numerals indicate like features and wherein:

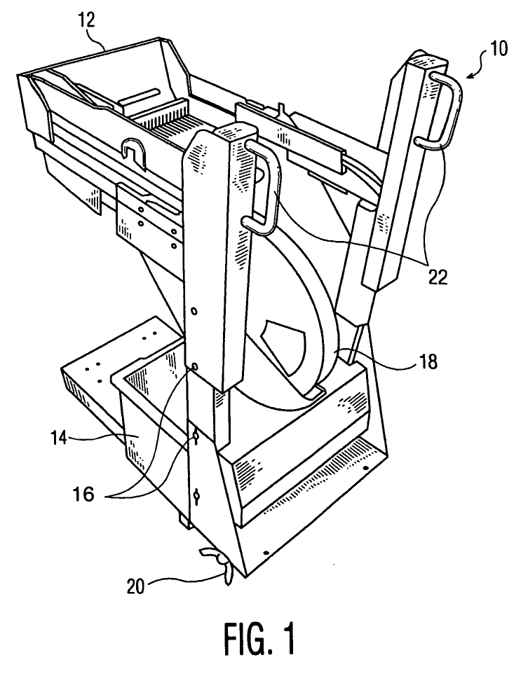

FIG. 1 shows a perspective view of a FES cart of the present invention;

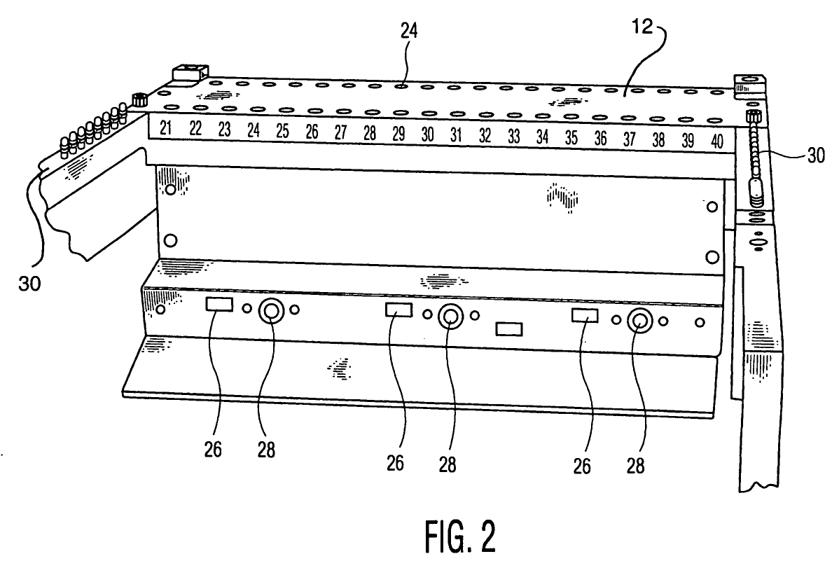

FIG. 2 illustrates one embodiment of the feeder plate assembly disclosed in FIG. 1;

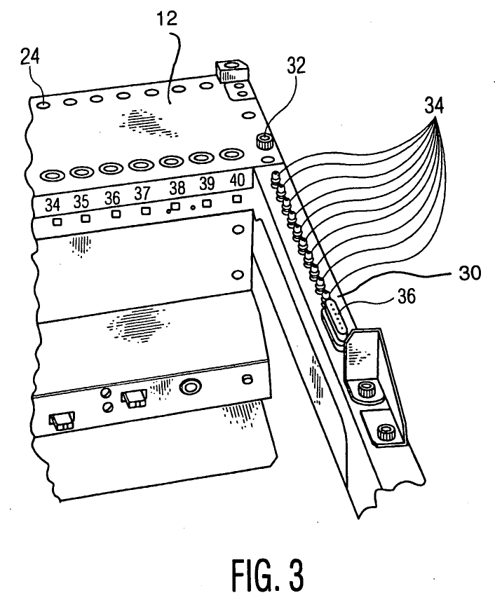

FIG. 3 illustrates the external feeder connections from the feeder plate mechanism to a surface mount machine;

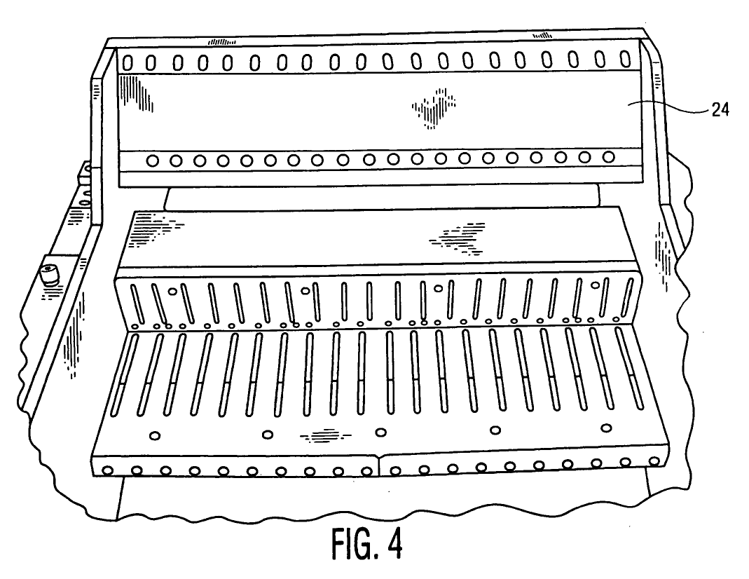

FIG. 4 further illustrates the feeder plate assembly contained within FIGS. 2 and 3;

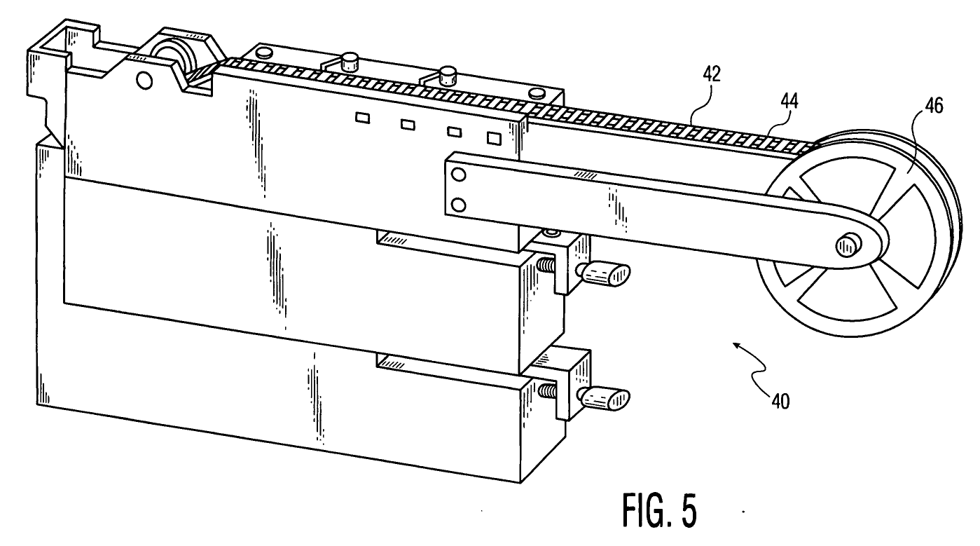

FIG. 5 provides a perspective view of a generic feeder mechanism;

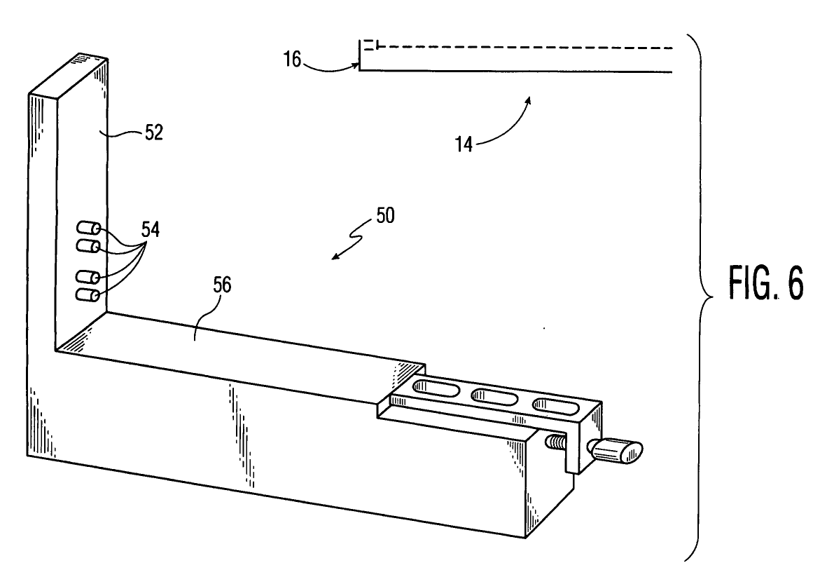

FIG. 6 illustrates a base operable to receive the feeder mechanism of FIG. 5;

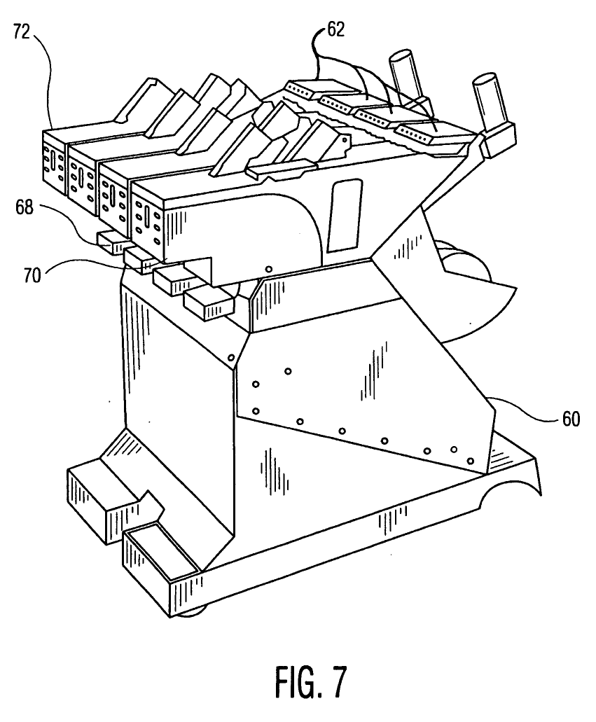

FIG. 7 provides a perspective view of an alternate embodiment of the FES cart provided by the present invention;

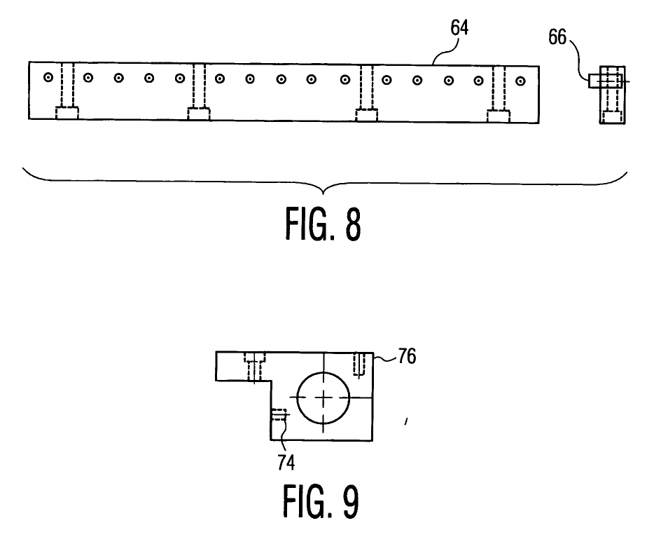

FIG. 8 depicts a rear pin lock plate feeder base assembly; and

FIG. 9, illustrates an L-shaped bracket within the feeder plate mechanism used to secure the feeder mechanisms in place.

Preferred embodiments of the present invention are illustrated in the Figures, like numerals being used to refer to like and corresponding parts of the various drawings.

The present invention provides a feeder exchange system (FES) that comprises a feeder exchange cart, trolley, or other interfacing device designed to provide seamless integration of feeders from various manufacturers to surface mount machines also of various manufacturers wherein the feeders are not necessarily designed to operate with that particular surface mount machine. Thus, for example, an FES cart may be adapted to integrate Fuji IP-3, Universal GSM, or other surface mount machines from various manufacturers to feeder mechanisms of yet other manufacturers known to those skilled in the art.

The present invention allows an operator to quickly load a FES cart with feeder mechanisms and insert or couple the FES cart onto a particular surface mount machine. The feeder mechanism type is selected by a selection means such as a software switch or other means as is known to those skilled in the art. Then, the program is run to assemble the PCBs. The FES cart may accommodate different types of feeder mechanisms, which are interfaced to different surface mount tools such that no machine adaptations of the feeder or the surface mount machine are required to facilitate a necessary and proper interface. The interface includes air supply, pneumatics, electronic control signals, power signals or other required umbilicals as known to those skilled in the art and is provided on the FES cart. The present invention thus allows end users to utilize feeders not specifically designed for their surface mount assembly machines. Users may utilize existing feeders with new surface mount tools, as opposed to purchasing new feeder mechanisms, allowing the cost of ownership of purchasing new surface mount machines to be reduced for the end users.

The FES cart provided by the present invention facilitate fast changeovers from one surface mount machine to another surface mount machine by switching a complete feeder plate with a number of feeder mechanisms. Feeder plates, mounted on the carts, allow offline feeder setup, thus reducing or preventing tool downtime. These FES carts are easily moved from a setup area to a surface mount machine and back. The option is available for FES carts to interface with the front right, front left, rear right or rear left of a standard surface mount machine.

FIG. 1 provides a perspective view of a FES cart of the present invention. FES cart 10 includes feeder plate 12 which contain a number of feeder mechanisms. Although this embodiment may utilize tape feeder mechanisms, the present invention may be applied equally to tape, bulk, tube or other such feeder mechanisms as are known to those skilled in the art. As shown, feeder plate 12 may contain up to 20 8 mm tape feeders. Tape dump box 14 collects tape waste from the feeders (not shown). Height adjustment bolts 16 on frame 18 allow the height of the feeder plate to be adjusted in order to seamlessly integrate with the surface mount machine (not shown). Frame 18 may be easily moved and rolled into and out of position with casters 20. Casters 20 may have brakes to prevent movement while holding FES cart 10 firmly in place next to a surface mount tool. Handles 22 and casters 20 allow for easy positioning of FES cart 10.

FIG. 2 further illustrates one embodiment of the feeder plate assembly connection of feeder plate 12 discussed and described in FIG. 1. The feeder plate assembly allows multiple feeder mechanisms to be coupled to the feeder plate assembly and provides multiple umbilical connections to support the individual feeder mechanisms. These connections include pneumatic, hydraulic, electrical, mechanical, push rod, optical or other like methods of interfacing the feeder mechanisms as is known to those skilled in the art.

Feeder plate assembly 24 shown in FIG. 2 is a 20-feeder plate that includes three internal power/electrical connections 26 and air or pneumatic connections 28. Besides the internal feeder connections, there is also an external interface connection to the surface mount machine. Surface mount interface 30, shown on the right and the left edges of feeder plate assembly 24 is illustrated further in FIG. 3. In FIG. 3, feeder plate assembly 24 is clearly shown with external connections that include positioning pins 32 that guide and align the connection between the surface mount tool and FES cart 10, air or pneumatic connections 34, and electrical connections 36. Feeder plate assembly 24, shown in FIGS. 2 and 3 is further illustrated in FIG. 4.

It should be noted that the specifics associated with the FES cart 10 are dependent on the feeder mechanisms utilized with an intended surface mount machine to be utilized. The present invention in certain embodiments allows FES cart 10 to quickly and easily be modified by exchanging the top plate of the feeder base assembly to allow different feeder mechanisms from different manufacturers to be installed in a single type of feeder mechanism cart. Alternatively, this part allows the mechanical interface between the feeder mechanisms and the surface mount machine to be quickly changed out as needed. However, the electrical and pneumatic umbilical connections may require further modification to allow feeder mechanisms of one FES cart originally configured for a first type of surface mount machine to be configured for a second type of surface mount machine.

The goal of the present invention is not to change feeder mechanisms and surface mount machine combinations on a regular basis. Rather, the present invention provides an FES cart or other interface device capable of receiving a first type of feeder mechanism and interface that feeder mechanisms with a second type of surface mount machine or other assembly equipment from different manufacturers, where the combination of feeder mechanisms and surface mount machines was not originally intended. Although the FES carts are not intended to be repeatedly modified to accommodate different feeders, FES carts may be refitted to accommodate different feeder mechanisms or have the interfaces associated with the cart refitted to interface with different surface mount machines.

The present invention provides a significant advantage by allowing the owner of a surface-mount machine from a first manufacturer to, for example, install an FES feeder cart containing feeder mechanisms made by a second manufacturer. Further, this FES cart may be removed and replaced with another FES cart containing feeder mechanisms made by a third manufacturer. The primary advantage being these components interface seamlessly. The only change necessary at the surface-mount machine is to select a program or toggle a software switch that selects a different control program associated with that new feeder mechanism.

For ease of connection and alignment, the mechanical interface with the surface mount machine, the FES carts have various positioning pin and tap interfaces that guide and lock the mechanisms in place.

FIG. 5 illustrates a perspective view of an interchangeable feeder mechanism 40 used in conjunction with various surface mount machines. The feeder is used for feeding a conventional carrier tape 42 with indexed pockets 44 that contain small components used in conjunction with various conventional pick and place assembly machines for surface mounting of small components onto printed circuit boards. The carrier tape 42 is wound upon reel 46.

A typical prior art configuration will have a plurality of slot-shaped bases such as the one shown in FIG. 6 wherein in the L-shaped base 50 has a vertical power rail 52, contact pins 54, and a horizontal support 56. Contact pins 54 provide electrical and pneumatic connections to the feeder mechanism shown in FIG. 5. Surface mount machines typically have a plurality of slot-shaped bases similar to the L-shaped bays shown in FIG. 6

As stated previously, the present invention provides a system and method of seamlessly integrating feeder mechanisms to a surface mount machines. This is achieved by providing a cart, trolley, or other interchangeable movable device, which holds a plurality of feeder mechanisms and provides electrical and pneumatic umbilical connections to and from the surface mount machine and the feeder mechanisms.

FIG. 7 provides a perspective view of another embodiment of an FES cart, as provided by the present invention. FES cart 60 holds or contains a plurality of feeder mechanisms 62. A rear pin lock plate feeder base assembly 64 holds feeder mechanisms 62 in place relative to the FES cart 60 at the rear. Assembly 64 is clearly shown in FIG. 8. Positioning or dowel pins 66 hold feeder mechanisms 62 in place relative to FES cart 60. To hold the feeder mechanisms in place relative to the forward of the cart, a front shield feeder lock 68 is provided. Left and right side plates 70 further defines the space with which the FES cart may receive feeder mechanisms 62. An L-shaped dowel holder, or front feeder lock 72 further helps secure feeder mechanisms 62 and additionally may contain taps or pins operable to receive dowels or holes from the feeder mechanisms, as illustrated by caps 74 within the L-shaped brackets 76 shown in FIG. 9. The front shield assembly shown in FIG. 7 allows tape from the reels of the feeder mechanisms to be directed to a waste bin located at the bottom of the feeder cart. This eliminates the need for cutter assemblies often used with feeder mechanisms that have an inherent danger associated with the feeder mechanism.

The present invention provides an advantage by offering the ability to interchangeably use feeder mechanisms with various surface mount assembly machines. This allows users to employ existing feeder mechanisms.

The repositionable carriage of the present invention provides a set of height support adapters so that the feeder plate mechanism can be adjusted to the pick height requirement for each surface mount assembly machine.

The present invention also may incorporate both flip-chip and non-flip-chip capabilities, and the ability to accommodate different carrier tape widths.

The present invention provides a significant advantage by allowing feeders to service various surface mount machines with the selection of an appropriately configured interfacing device, thus allowing manufacturers to use their existing inventory of feeder mechanisms with a diverse set of surface mount machines.

Although the present invention is described in detail, it should be understood that various changes, substitutions and alterations can be made hereto without departing from the spirit and scope of the invention as described by the appended claims.

In summary, the present invention provides an interfacing device that integrates feeders mechanisms and surface mount machines of differing manufacture. This interfacing device includes a carriage to which a feeder plate mechanism is mounted. The carriage provides external feeder connectors from the surface mount machine to the feeder plate mechanism. Feeder mechanisms, received by the feeder plate mechanism, have internal feeder connectors, which connect from the feeder plate mechanism to the feeder mechanisms themselves. Thus, the feeder plate mechanism can adapt the external feeder connectors on a particular surface mount machine of one manufacturer to the internal feeder connectors of the feeder mechanisms of another manufacturer.

1. An interfacing device that integrates feeder mechanisms and surface mount machines of differing manufacture, the interfacing device comprising:
a carriage to which a feeder plate mechanism is mounted, wherein said carriage provides external feeder connectors from a surface mount machine to the feeder plate mechanism; and
a plurality of feeder mechanisms that are received by said feeder plate mechanism, wherein said feeder mechanisms provide internal feeder connectors from said feeder plate mechanism to said plurality of feeder mechanisms, and wherein said feeder plate mechanism adapts said external feeder connectors to said internal feeder connectors.

2. The interfacing device of claim 1, wherein said external feeder connectors comprise pneumatic and electrical connections.

3. The interfacing device of claim 1, wherein said internal feeder connectors comprise pneumatic and electrical connections.

4. The interfacing device of claim 1, wherein a switch within the surface mount machine is configured to enable an operator to select a type of feeder mechanism within said interface device.

5. The interfacing device of claim 1, wherein positioning pins within said interfacing device align components coupled by said internal feeder connectors and said external feeder connectors.

6. The interfacing device of claim 1, wherein said feeder plate mechanism comprises a top plate assembly used to couple said feeder plate mechanism to the surface mount machine.

7. The interfacing device of claim 1, wherein said carriage comprises a tape dump operable to catch spent feeder tape expended by one of the feeder mechanisms.

8. The interfacing device of claim 1, wherein said carriage comprises rolling members that are configured to enable an operator to easily reposition the interfacing device to and from the surface mount machine.

9. The interfacing device of claim 1, wherein said feeder plate mechanism comprises one or more locks to secure said feeder mechanisms within said feeder plate mechanism.

10. The interfacing device of claim 1, wherein said carriage comprises a frame of adjustable height.

11. A method of interfacing and integrating feeder mechanisms to surface mount machines of differing manufacture, the method comprising the steps of:
mounting a feeder plate mechanism to a carriage, wherein said carriage provides external feeder connectors from a surface mount machine to the feeder plate mechanism:
connecting a plurality of feeder mechanisms to said feeder plate mechanism, wherein said feeder mechanisms couple to said feeder plate mechanism via internal feeder connectors, and wherein said feeder plate mechanism adapts said external feeder connectors to said internal feeder connectors:
coupling said carriage to the surface mount machine, and
selecting via a switch within the surface mount machine the type of feeders contained within said feeder plate mechanism.

12. The method of claim 11, wherein said external feeder connectors and said internal feeder connectors comprise pneumatic and electrical connections.

13. The method of claim 11, wherein positioning pins within said interfacing device align components coupled by said internal feeder connectors and said external feeder connectors.

14. The method of claim 11, wherein said feeder plate mechanism comprises a top plate assembly used to couple said feeder plate mechanism to the surface mount machine.

15. The method of claim 11, wherein said carriage comprises a tape dump operable to catch spent feeder tape expended by one of the feeder mechanisms.

16. The method of claim 11, wherein said carriage comprises rolling members that are configured to enable an operator to easily reposition the interfacing device to and from the surface mount machine.

17. The method of claim 11, wherein said feeder plate mechanism comprises one or more locks to secure said feeder mechanisms within said feeder plate mechanism.

18. The method of claim 11, wherein said carriage comprises a frame of adjustable height.

19. An interfacing device that integrates feeder mechanisms and surface mount machines of differing manufacture, the interfacing device comprising:
a carriage to which a feeder plate mechanism is mounted, wherein said carriage provides external feeder connectors from a surface mount machine to the feeder plate mechanism and wherein said external feeder connectors comprise pneumatic and electrical connections;
a plurality of feeder mechanisms that are received by said feeder plate mechanism, wherein said feeder mechanisms provide internal feeder connectors from said feeder plate mechanism to said plurality of feeder mechanisms, wherein said internal feeder connectors comprise pneumatic and electrical connections, wherein said feeder plate mechanism adapts said external feeder connectors to said internal feeder connectors, and wherein mechanical stops and positioning pins secure said feeder mechanisms within said feeder plate mechanism; and
a means for selecting a type of feeder mechanism contained within said interface device.

20. The interfacing device of claim 19, wherein said carriage comprises:
a tape dump operable to catch spent feeder tape expended by one of the feeder mechanisms;
rolling members that are configured to enable an operator to easily reposition the interfacing device to and from the surface mount machine; and
a means for adjusting a height of said carriage.

21. The interfacing device of claim 8, wherein said rolling members are casters.

22. The method of claim 16, wherein said rolling members are casters.

23. The interfacing device of claim 20, wherein said rolling members are casters.
